(19) United States
(12) Patent Application Publication
(10) Pub. No.: US 2003/0210271 A1
(43) Pub. Date: Nov. 13, 2003

(54) Power based level-of- detail management system for a portable computer graphics display

(76) Inventor: William Davis King, Atlanta, GA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/145,234

(22) Filed: May 13, 2002

(51) Int. Cl. G09G 5/00

(52) U.S. Cl. 345/771; 345/864; 345/744

(57) ABSTRACT

A system and method for allowing a portable electronic device capable of processing and displaying graphics applications, such as a laptop, hand held computer, PDA, or internet ready wireless cellular device, to continue to display graphics even when battery power is low. The present invention extends the useful battery life by actively managing and appropriately reducing the level of detail or image quality of graphics rendered by the device as function of available power. In a preferred embodiment, the invention manages the level of detail at the application level so it does not affect processor speed.

### FIELD OF THE INVENTION

The invention relates generally to computer graphics. More specifically, the invention relates to a method and apparatus for changing the level of detail in computer graphics as a function of available power.

### BACKGROUND OF THE INVENTION

Portable laptops, handheld computers, personal digital assistants (PDA's) and or wireless cellular internet ready devices, such as internet ready cell phones, are often powered by a finite portable power source such as a rechargeable battery or fuel cell. A major problem for users of these laptops, handheld computers, personal digital assistants (PDA's) and/or other portable devices is that certain graphics applications, such as multimedia or video applications, consume large amounts of power when rendering the graphics to be displayed on these devices. These applications can drain significant power. Accordingly, when available power is low, the users of laptops, handheld computers and other portable devices must often stop watching a movie, playing a game, or viewing a graphics application until they can recharge/replace the battery or reload/replace the fuel cell.

Currently, power drain caused on portable power sources by the processing and display of graphics applications is handled by adjusting processor resources and processor speed. More specifically, there are numerous applications adapted to adjust the processor clock frequency, while the processor is running a graphics application, in order to adjust power consumption. Intel's SpeedStep™ technology and Transmeta's LongRun power management are two such applications.

In a traditional microprocessor, the clock frequency is constant, and the processor's speed, measured in clock cycles per second, is also constant. The Intel SpeedStep™ allows a processor to switch between two different frequencies, a high frequency that drains the power more quickly, and a low frequency that drains the power more slowly. However, operation at the lower frequency comes at the expense of a significant loss in performance. Meanwhile, Transmeta's LongRun allows a processor to vary its clock rate continuously across a wide range of frequencies in order to save power as its workload changes.

When portable devices employ this technique, the graphics application may run slower and/or the graphics may become displayed in a choppy, interrupted, non-continuous fashion. In some instances (such as streaming video applications), the graphics application may altogether fail. Accordingly, what is needed is a mechanism for extending the life of the portable power source by actively managing and appropriately reducing the level of detail or image quality of graphics to be displayed without necessarily reducing the processor speed and/or interrupting the continuity of the images to be displayed.

### SUMMARY OF THE INVENTION

A system and method for allowing a portable electronic device capable of processing and displaying graphics applications, such as a laptop, hand held computer, PDA, or internet ready wireless cellular device, to continue to display graphics even when available power is low. The present invention extends the useful life of a portable power source by actively managing and appropriately reducing the level of detail or image quality of graphics rendered by the device as function of available power. In a preferred embodiment, the invention manages the level of detail at the application level so it does not affect processor speed.

Overall, three of the major power uses in a graphics system are moving primitive data from the memory onto the system bus, performing complex floating point computations, reiteratively processing the data within the graphics chip, and accessing new data on the disk. The tradeoffs among these are machine-dependent, but the power tradeoffs often vary from the speed tradeoffs. The level of detail control methods utilized in a preferred embodiment of the present invention may include methods for reducing the number of floating point operations, methods for reducing the number of passes through a multi-stage graphics pipeline, and methods for reducing the amount of primitive data on the system bus.

Preferably, the invention makes image rendering quality choices automatically in response to a pre-set user selected image quality level and internal information on available power, current power usage, and target power levels. Alternatively, a number of specific types of image rendering quality tradeoffs may be available and a user may select which tradeoffs he wishes the system to utilize. Using the specific user selected tradeoffs, and internal information on available power, current power usage, and target power levels, the invention adjusts the level of detail of the image.

In a preferred embodiment, a single power level of detail control panel interface is implemented in software and allows a user to select a desired image quality level (such as high, medium or low) that will be used when graphics applications are processed. The control panel is a virtual interface that may be set using an input device such as a mouse, keyboard or keypad, stylus, trackball, etc. Alternatively, the interface may provide the user with a number of specific types of image rendering quality tradeoffs and a user may select which tradeoffs he wishes the system to utilize. Using these user select tradeoffs, the invention makes alterations in the level of detail at the application level as needed based upon the power statistics and the user selected trade-offs.

In a preferred embodiment, the adjustments to the level of detail in the images are performed as a function of power levels, and may be set as a function of power level, or as a function of the desired length of time (or battery life) over which the available power should last as determined by the user.

### DESCRIPTION OF THE DRAWINGS

FIG. 1 illustrates a functional block diagram that shows a preferred embodiment of a computer program utilizing the present invention;

FIG. 2 is a simplified block diagram of the sort middle graphics architecture utilized in a preferred embodiment of the present invention

FIG. 3 illustrates a flow chart that shows the normal operation of the sort middle graphics architecture when power is at a maximum level;

FIG. 4 illustrates a Level of Detail panel interface for user selected image rendering tradeoffs in accordance with a preferred embodiment of the present invention;

FIG. 5 illustrates a flowchart that shows the preferred steps for managing the level of detail of graphics images as a function of the available power in accordance with a preferred embodiment of the present invention; and

FIG. 6 illustrates another preferred embodiment of a Level of Detail Panel interface for selecting desired image level of detail tradeoffs as a function of power.

### DESCRIPTION OF PREFERRED EMBODIMENT

A system and method for allowing a portable electronic device capable of processing and displaying graphics applications, such as a laptop, hand held computer, PDA, or internet ready wireless cellular device, to continue to display graphics even when the power source is low or in or to display graphics for a longer period of time when the power source is only capable of delivering a finite, limited amount of power. The present invention extends the useful life of the power source by actively managing and appropriately reducing the level of detail or image quality of graphics rendered by the device as a function of the available power level, or as a function of the desired length of time (or battery life) over which the available power should last as determined by the user. In a preferred embodiment, the invention manages the level of detail at the application level so it does not affect processor speed.

Overall, three of the major power uses in a graphics system are moving triangle data from the memory onto the system bus, performing complex floating point computations, reiterative processing the data within the graphics chip, and accessing new data on the disk. The tradeoffs among these are machine-dependent, but the power tradeoffs often vary from the speed tradeoffs. The level of detail control method utilized in a preferred embodiment of the present invention includes methods for reducing the number of floating point operations, methods for reducing the number of passes through a multi-stage graphics pipeline, and methods for reducing the amount of triangle data on the system bus.

Preferably, the invention makes image rendering quality choices automatically in response to a pre-set user selected desired image quality level and internal information or power statistics for available power, current power usage, and target power levels. In a preferred embodiment, a single power level of detail control panel interface is implemented in software and allows a user to selected a desired level for image quality (such as high, medium or low) that will be used when graphics applications are processed. The control panel is a virtual interface that may be set using any input device such as a mouse, keyboard or keypad, stylus, trackball, etc.. Alternatively, the power level of detail control panel interface may provide the user with a number of specific types of image rendering quality tradeoffs and a user may select which tradeoffs he wishes the system to utilize. Using these user select tradeoffs, the invention makes alterations in the level of detail at the application level as needed based upon the power statistics and the user selected trade-offs.

Using the desired image quality level or the specific user select tradeoffs, the invention makes alterations in the level of detail at the application level as needed based upon the power statistics and the user selected trade-offs. In a preferred embodiment where the user simply selects a desired image quality level, the invention adjusts the level of detail using any one of or several different methods designed to reduce the number of floating point operations, or reduce the number of passes through a multi-stage graphics pipeline, or reduce the amount of primitive data on the system bus. Accordingly, utilizing any one of several methods designed to reduce the amount of primitive data, the invention may reduce the number of objects displayed in a single frame, with data for any one object (or several objects) being ignored and not sent to the graphics processor. Alternatively, the resolution of the objects within a frame may be compromised, i.e. the number of bits or available colors used to represent the object may be reduced.

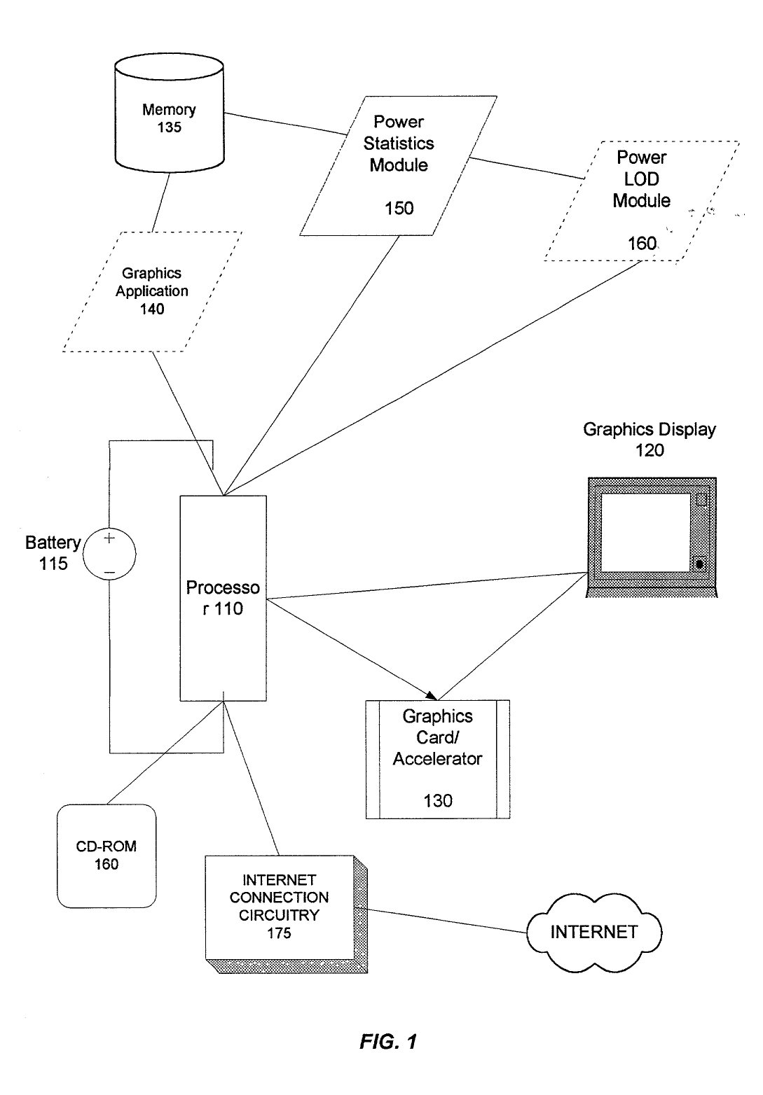

FIG. 1 illustrates a functional block diagram that shows a preferred embodiment of a computer system 100 that utilizes a power level of detail management system and method in accordance with a preferred embodiment of the present invention. As shown, the system 100 includes a processor 110 implemented within a portable laptop, handheld computer, personal digital assistant, or wireless cellular Internet ready device, such as an Internet ready cell phone. The processor 110 is coupled to a battery 115, a video graphics display 120, and a video graphics card or graphics accelerator 130. In a preferred embodiment, the processor may also be coupled to a memory 150 and a CD-ROM drive 160. The system may also preferably include Internet connection circuitry 175 (such as a built-in modem) for coupling the system to the Internet via POTS, a DSL line, a T1 line or any other viable telecommunication means for coupling to the Internet.

Preferably, the processor is configured to execute a graphics application 140 (displayed in broken lines to represent software). The graphics application typically requires that video graphics be rendered by the system and displayed on the display. The graphics to be rendered may come from a disc played in the CD-ROM drive, the memory, or via the Internet connection interface. The complete set of instructions and all of the data used for rendering the graphics are broken up into sets known as primitives. These primitives are passed to the video graphics card or graphics accelerator 130, where they are processed for display. In a preferred embodiment, the graphics card utilizes a sort middle graphics architecture, although it is understood that the card may utilize any other type of graphics architecture, such as a sort first architecture, and the invention is in no way limited by the graphics card architecture since it is performed at the application level.

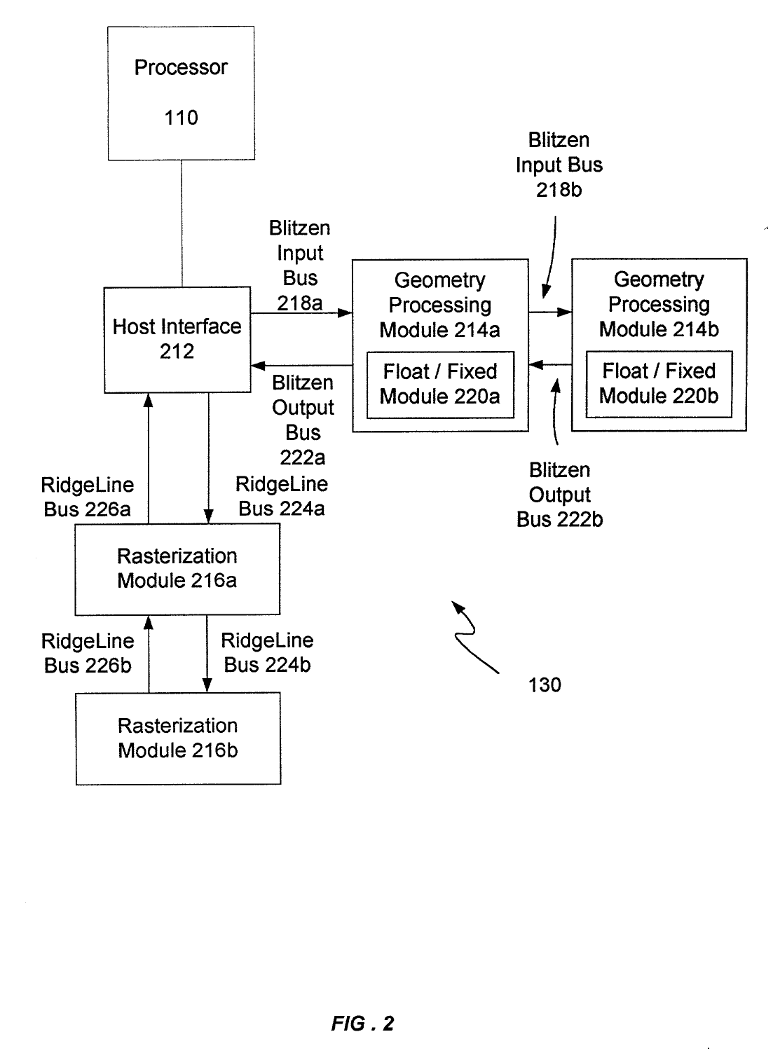

FIG. 2 is a simplified block diagram of the sort middle graphics architecture utilized in a preferred embodiment of the present invention. As shown, the sort middle graphics architecture includes a host interface 212, a series of geometry processing modules 214a-b, and a series of rasterization modules 216a-b. The geometry processing modules 214a-b are daisy-chained in a point to point configuration and are coupled to each other and the host interface 212 via Blitzen input bus lines (BIBs) 218a-b and Blitzen output bus lines (BOBs) 222a-b. The geometry processing modules 214a-b each include a float to fixed point data format module 220a-b for converting the output from the geometry processing module from floating point format into a fixed point data format. The host interface 212, also known as a Heathrow system, is coupled to the processor that is running the graphics application.

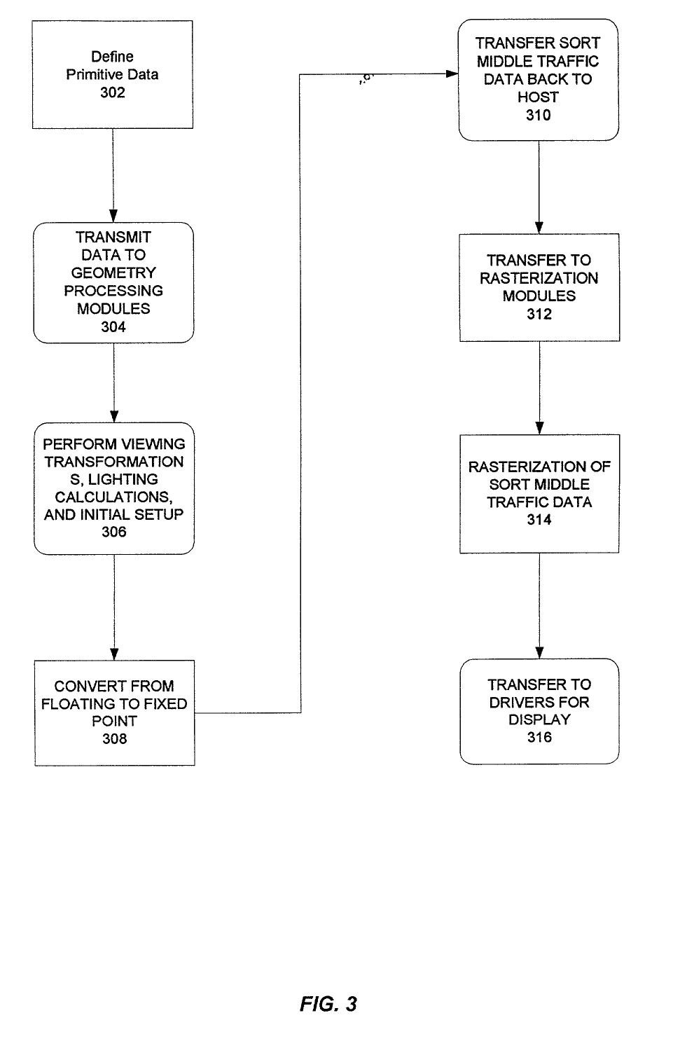

FIG. 3 illustrates a flow chart that shows the normal operation of the sort middle graphics architecture when power is at a maximum level. As shown, the graphics application running on the computer system defines a primitive, such as a triangular space, point or line, within a frame and determines primitive vertex data for the vertices of the triangular space, point or line, along with setup variables that define associated texture coordinates, texture maps, z-depth, color, and other material properties of the pixels within the primitive (302). Preferably, the vertices of a primitive are typically floating point values made up of thirty-two bits. Under a typical graphics pipeline protocol, there are n bits, indexed from zero to n−1, in a word containing the values. The setup variables may are also typically represented as floating point values. For example, the z depth may be represented as forty bits, while color components may be represented as twenty-four bits. The primitive data is then assigned to one of the geometry processing modules, through a round robin assignment process, and is transmitted from the host interface to the geometry processing modules via the Blitzen input buses (304).

Once the primitive data arrives at the assigned geometry processing module, the geometry processing module performs viewing transformations (i.e. transforms the vertices for the triangle into screen space coordinates), lighting calculations at the vertices, and initial setup and computation of slopes for use by the rasterization modules (306). The output from the geometry processing modules is referred to as sort middle traffic data or rasterization setup data and it includes a plurality of plane equations These plane equations are the starting values and slopes for all of the parameters of the primitive or triangular space.

Referring again to FIG. 2, each geometry processing module includes a float/fixed module 220 configured to convert the floating point data to fixed-point data. Accordingly, the sort middle traffic data is converted from floating to fixed point format (308) and then transferred back across to the host interface (310). From the host interface, the data is sent over the RidgeLine bus to the rasterization modules, that perform rasterization and texture mapping (312). The rasterization modules are configured to perform the rasterization and are preferably scan-lined interleaved such that all the sort middle traffic data is sent to each of the rasterization modules. The rasterized and texture mapped data is then provided to drivers (not shown) that are coupled to the graphics display for rendering the graphics image.

Referring again to FIG. 1, the invention further includes a power statistics module 150 and a Power/Level of Detail (LOD) management module 160. In a preferred embodiment, both of these modules are implement in software (as indicated by the use of broker lines in FIG. 1), although they may also be implement in hardware or firmware, or any combination thereof The power statistics module and the Power LOD management module are called into operation whenever a graphics application is executed by the processor.

It is known in the art to equip a portable laptop, handheld computer, personal digital assistant, or wireless cellular Internet ready device, such as an Internet ready cell phone, with power monitoring circuitry that reports battery capacity, including maximum capacity, remaining battery charge, and drain rate of the battery. Additionally, it is possible to include a power sensor on the graphics chip or memory system, to compute power usage directly from the voltage drop across the chip. In this way, the actual power consumed by the graphics card can also be measured. In a preferred embodiment of the present invention, the computer system is equipped with such power monitoring circuitry used for measuring available and consumed power.

In a preferred embodiment, when the processor executes any type of graphics application, the power statistics module 150 enables the processor to receive information on power usage and remaining battery life from the power monitoring circuitry. In a preferred embodiment, the processor includes a power sensor that also provides information regarding the consumption of power by the graphics card or graphics accelerator. The power statistics module tracks and records this information. It also calculates the rate of usage of power by comparing previous power statistics with current power statistics.

The power statistics module monitors this information and provides this information to the Power/LOD management module 160 at regular update intervals. Using this information, and preferred image quality level selected by the user, the Power/LOD management module controls the operation of the application. More specifically, the Power/LOD management module instructs the application to perform any one of several different steps designed to modify the level of detail in the rendered images, in accordance with the desired image quality level. The specific steps for adjusting the level of detail are variable from application to application and are described in greater detail further hereinafter.

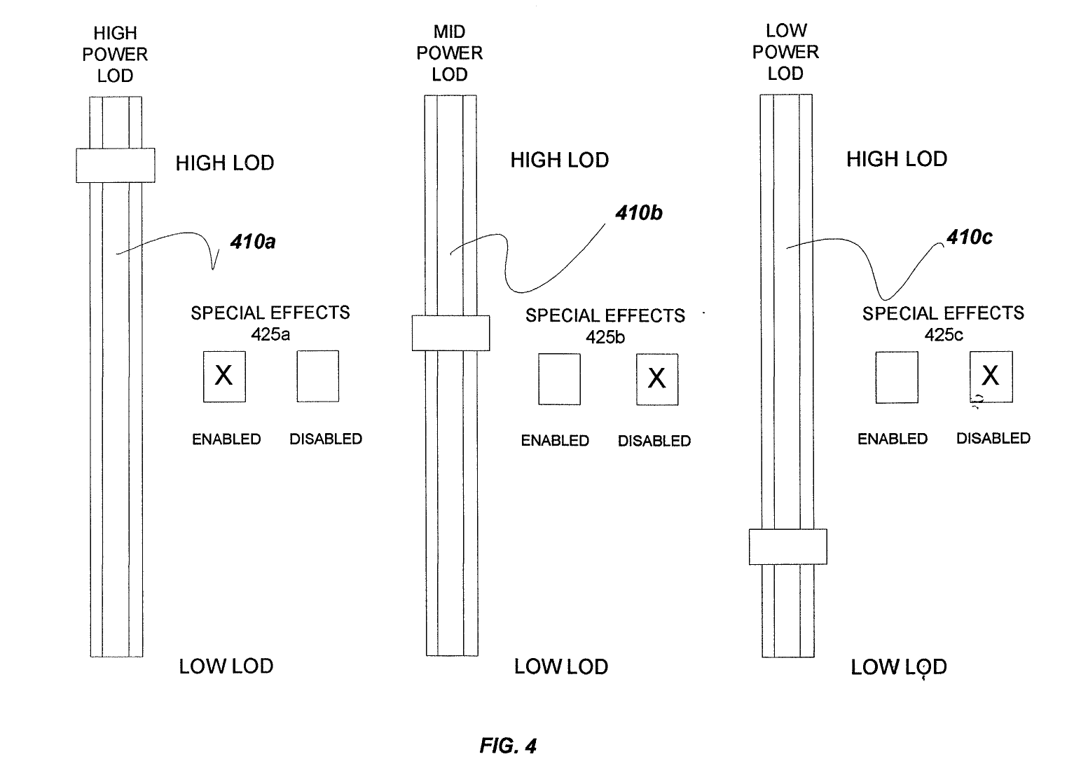

The invention further includes a user interface for allowing users to select and set the desired image level of detail. This interface is preferably implemented through software in the form of a virtual panel or switchboard, referred to hereinafter as a Level of Detail (LOD) Panel, which is displayed on the display. FIG. 4 illustrates a preferred embodiment of a LOD Panel that allows a user to select a preferred image quality level or level of detail as a function of available power statistics and, more specifically, as a function of the available power level.

As shown, in a preferred embodiment, the panel is comprised of a number of graphical user interface devices including three interactive slide switches 410a-c and a set of selection boxes 425a-c, that accompany each of the interactive slide switches. The first slide switch 410a corresponds with the High Power LOD settings. While the second 410b and third 410c switches correspond with mid-power and low power LOD settings. The switch settings may be adjusted by using an input device such as a mouse, keyboard, touch screen, stylus, joystick, trackball, etc. to select the respective switch in the panel display and move the switch by sliding it up or down. In a preferred embodiment, the slide switch actually has predetermined gradations such that as the switch is moved up or down, it is positioned to the closest gradation. The number of gradations per switch may vary although, in a preferred embodiment, the switch will preferably have at least two different grades.

In a preferred embodiment, the Power/LOD management module 160 received power statistics at regular update intervals and utilizing these statistics is able to determine whether the system is at a high power, mid-power, or low power level. For example, the Power/LOD management module various power statistics including information on remaining batter life. It may compare this information with pre-determined threshold levels in order to determine whether the system is at a high power, mid-power, or low power level. Once the Power/LOD management module determines whether the system is at a high power, mid-power, or low power level, it utilizes the switch settings for that level to adjust the level of detail in the rendered graphics. Therefore, using the settings set forth in FIG. 4, the application will render graphics at a high level of detail if the system is operating at a high power level or it will render graphics at a much lower level of detail if the system is operating at a low power level.

As further shown, specific selection boxes 425a-c may accompany each of the interactive slide switches, allowing a user to enable or disable certain graphical features as a function of power levels. For example, the special selection boxes may allow a user to enable or disable special effects that may normally appear in the graphics when the are rendered. Special effects may include such things as 3-D motion effects may show trees moving due to wind, or water rippling or flowing. Often these effects are run in the background to give the application a much more authentic and real feeling; but, they can be disabled in order to conserve power, without detracting from the overall quality of the graphical image. It understood other interactive graphic use interface devices may be utilized for allowing the user to select level of detail tradeoffs as function of power.

In a preferred embodiment, the user will set the desired image quality level or level of detail as a function of available power, at different power levels, before the graphics application is executed/run and these settings will remain constant until adjusted by the user as a later time. Alternatively, the user may on be prompted by the computer system to adjust the level of detail or image quality level as power levels decrease, thereby allowing the user to adjust the desired image quality level or level of detail at different stages.

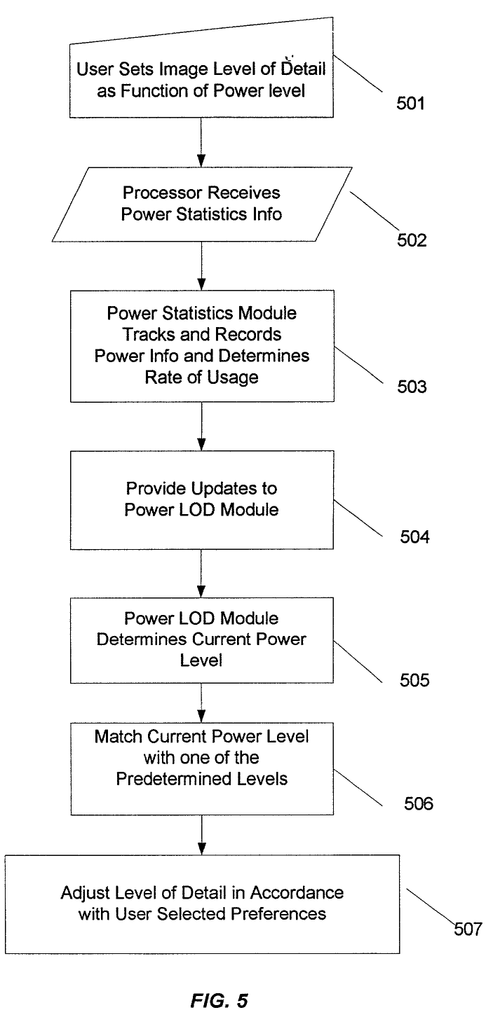

FIG. 5 illustrates a flowchart that shows the preferred steps for managing the level of detail of graphics images as a function of the available power. As shown, the first step in the process is for the user to select and set the preferred image quality levels or levels of detail (501). The image quality levels may be set as functions of power levels, or as functions of remaining power source life, the time over which the available power should last as determined by the user. Using a software interface in the form of a virtual panel or switchboard, a user selects various preferred image rendering quality or level of detail as a function of predetermined power levels or as a function of predetermined remaining life levels. For example, the user may select a first desired image quality level or level of detail when the power source is at a first power level or when it the power source has a certain remaining useful life. The user may then select a second different image quality level or level of detail for use when the power source falls below a certain power level or has only half of its remaining life.

In a preferred embodiment, the software interface will be very basic and the user will set these tradeoffs between power levels and level of detail before the graphics application is executed/run and these settings will remain constant until adjusted by the user at a later time. These desired image quality level or level of detail is preferably in the form of image quality choices such as “high”, “medium” or “low” image quality options for each predetermined power level or remaining source life.

Next, the processor executes/runs a graphics application and as the processor executes the application, a power statistics module is automatically executed that allows the processor to receive useful information and power statistics, such as statistics on power usage and remaining battery life (502). The power statistics module receives this information from the processor and tracks/records this information. In a preferred embodiment, the processor will also receive information regarding the consumption of power by the graphics card or graphics accelerator. Using this information, the power statistics module can determine the rate of usage of power (503). All of this statistical information is then provided to a Power LOD management module 160 (504).

Using the information received from the power statistics module, the Power/LOD management module then determines the current power level (505). The Power/LOD management module then matches the current power level with one of the predetermined levels in the virtual panel or switchboard that was used to select the various preferred image quality level or levels of detail (506). The Power/LOD management module then adjusts the level of detail of the output image as a function of the user selected level of detail (507). More specifically, using the user select image quality level or level of detail, the Power LOD management module alters the level of detail at the application level as function of the available power/power consumption. Adjustment of the level of detail may be accomplished in any one of several ways. For example, the number of objects displayed in a single frame may be reduced, with data for any one object (or several objects) being ignored and not sent to the graphics card or graphics accelerator. Alternatively, the amount of data used to represent any object may be reduced. Even further, the resolution of the objects within a frame may be compromised by reducing the number of iterations through the graphics pipeline or eliminating some of the image processing steps in the pipeline.

Preferred Methods for Reducing the Level of Detail

As explained above, there are several ways in which the level of detail may be reduced. This section provides several examples of preferred methods that may be invoked in order to reduce the level of detail of the rendered graphics images.

Wireframe—a common method in CAD/CAM work and in early video games was to choose between drawing isolated points, drawing points connected by lines (wireframe), and drawing complete, filled-in polygons. Many CAD systems for example allow the user to switch views, since many large models cannot be drawn with full polygons at rates fast enough for interactive design use. Accordingly, selective use of a wireframe technique as a function of power in certain graphics applications can significantly conserve power resources.

Texture map resolution—many graphics applications cover models with images known as texture maps. The texture maps are stored in a pyramid structure called a MipMap that allows the level of detail to change smoothly as the user zooms in and out. Its primary purpose is to improve image quality, as using too much detail can produce bad image artifacts. The application can preferably change MipMap levels as a function of power, thereby reducing the level of detail even further. To be more specific, a MipMap might contain versions of the same image stored as several different pixel arrays (4×4, 8×8, 16×16, 32×32, 64×64 etc.). In a gaming application where there is motion the application may be configured to render the image at the 32×32 array for a given zoom rate or speed, while the 64×64 array may be optimal for quality when stationary. In a preferred embodiment, the application can reduce the level of detail to 32×32 as a function of power, and not just motion, in order to perform ¼ the rendering work that 64×164 requires.

Antialiasing—antialiasing is a common graphics operation that makes ‘jaggy’ edges look nice and smooth. It is used in most advanced graphics cards and, currently, some gaming applications allow this featured to be turned on and off in order to adjust the speed of the application for users with inferior or slower processors. In a preferred embodiment, the antialiasing feature may also be deactivated as a function of power.

Primitive simplification—many 3D objects used in graphics are stored as meshes of triangles, points and/or lines (primitives, which were discussed earlier, are used to describe each of these triangles, points and/or lines). Primitives are often rendered in order of their z coordinates in order to produce detailed 3-D images and reduce the negative image effects of overlap. In a preferred embodiment, the number and size of these primitives can be varied to reduce the level of detail as a function of power. Additionally, the bit resolution used to describe each pixel within each primitive may also be varied (by reducing the number of available colors for example) in order to reduce the volume of data used to render each primitive and effectively manage power consumption.

Floating point precision—one technique use to reduce power consumption is to change the precision of rendering computations such as square roots, divides, and matrix multiplies. By simplifying the performance of floating point computations in software, even by only one decimal place at a time; the application can reduce the number of bits needed and simply operations, thereby conserving considerable power.

Lighting computations—computer graphics quality is often determined by the sophistication and complexity of the code used to compute lighting effects. For example, it is possible to render a scene with two, three, four or even more light sources. There are many techniques that may be used to provide quality shading and shadowing as a function of the number of light sources and the complexity of the application. Some of the more common methods for lightening and shading include Phong Shading, Goraud shading, and environment mapping. These methods can differ greatly in their time and power costs, as some require computing a vector product once per triangle and others require computing a vector product once per pixel. By reducing the number of light sources and using more simplified shading and shadowing techniques, the invention can conserve considerable power.

Turning off special effects—as explained earlier, many computer games will run special effects such as waterfalls, animations of fire in the background, fog, motion of images attributable to wind or running water. Often, these games provide a user interface allowing users on slow computers to turn off these features manually to speed up game play. In a preferred embodiment of the present invention, users can elect to disable these features as a function of available power resources as well.

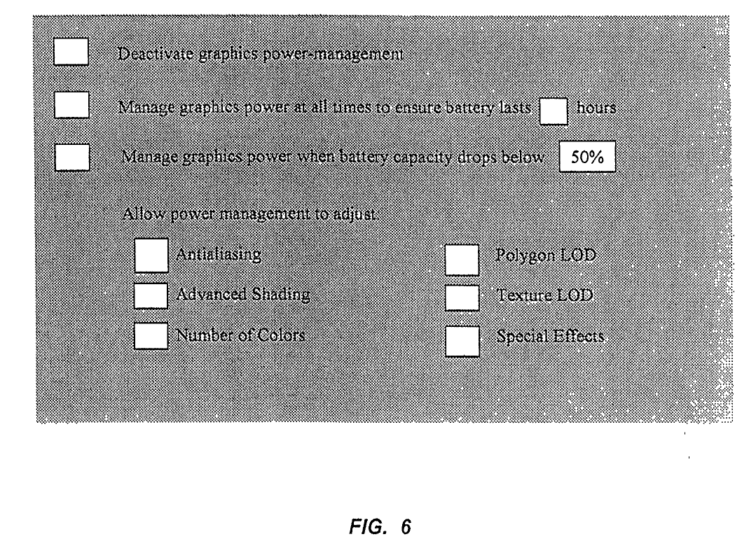

FIG. 6 illustrates another preferred embodiment of a LOD Panel for selecting desired image level of detail tradeoffs as a function of power. As shown in FIG. 6, another preferred embodiment of the LOD Panel includes an option for configuring the system to ensure that the battery will last a desired length of time. For example, the user may be executed a graphics application which allows him or her to view a video from a DVD on the portable device. The video on the DVD may have a running time of 2 hours and 15 minutes. Accordingly, the user may wish to select this option and configure the system to manage the level of detail in order to ensure that the battery power lasts over the entire length of the video.

Additionally, in the preferred embodiment shown in FIG. 6, the user may configure the system to manage the LOD once the battery power drops below a certain capacity. Alternatively, the user may select both boxes on the LOD Panel, thereby combining both features, in such a case, the system will manage the level of detail in order to ensure that the battery power lasts over the entire length of the video; but, will only begin actively managing the LOD once the battery power has dropped below a certain level. Alternatively, the user may select to disable the LOD management device altogether.

The LOD Panel shown in FIG. 6 is preferably utilized in systems used by more advanced users and, as shown, this embodiment of the LOD Panel allows the user to select which level of detail management techniques will actually be utilized by the system. Accordingly, in this embodiment, the user selects the actual LOD tradeoffs the system will implement as a function of available power. For example, if the user selects the “Advanced Shading” box on the LOD Panel, the system will reduce the number of light sources and use more simplified shading and shadowing techniques, as described in greater detail earlier herein. If the user selects the “Polygon LOD” box on the LOD Panel, the number and size of each primitive can be varied to reduce the level of detail as a function of power. Additionally, the bit resolution within each triangle may also be varied in order to reduce the volume of data used to render each triangle and manage power consumption. A user could elect not to select the “Special Effects” box on the LOD Panel, in which case, LOD management techniques which involve disabling any special effects, as described earlier herein, will not be used to manage the LOD as a function of power.

The foregoing detailed description of the present invention is provided for the purposes of illustration and is not intended to be exhaustive or to limit the invention to the precise embodiment disclosed. Several embodiments of the invention have been described that are provided for the purposes of illustration and are not intended to be exhaustive or to limit the invention to the precise embodiment disclosed. For example, the embodiments described herein have been described with reference to a sort middle graphics architecture. However, it is understood that the invention may be implemented in any type of graphics architecture, such as a sort first or sort last graphics architecture. Various embodiments may provide different capabilities and benefits depending on the configuration used to implement the key features of the invention. Accordingly, the scope of the present invention is defined and limited only by the following claims.

1. A method for adjusting the level of detail of graphics displayed by a portable device, said method comprising:
obtaining a plurality of user preferred levels of detail, each user preferred level of detail corresponding with a predetermined power level in a plurality of predetermined power levels;
determining a current power level;
selecting which user preferred level of detail to implement in displaying the graphics, said selection being a function of the current power level; and
adjusting the level of detail for the graphics display in order to achieve the selected user preferred level of detail.

2. The method of claim 1, wherein the step of obtaining a plurality of user preferred levels of detail is comprised of:
providing a graphical user interface for allowing a user to select the plurality of user preferred levels of detail, each level of detail corresponding with a predetermined power level in a plurality of predetermined power levels such that each power level in the plurality has a corresponding user preferred level of detail; and
receiving and storing the plurality of user preferred levels of detail.

3. The method of claim 1, wherein the step of selecting which user preferred level of detail to implement in the graphics display as a function of the current power level is comprised of:
comparing the current power level with each of the predetermined power levels in the plurality;
selecting one of the predetermined power levels from the plurality as a result of the comparison; and
selecting the user preferred level of detail which corresponds with the selected predetermined power level.

4. The method of claim 1, wherein the step of adjusting the level of detail for the graphics display in order to achieve the selected user preferred level of detail includes reducing a number of floating point operations.

5. The method of claim 1, wherein the step of adjusting the level of detail for the graphics display in order to achieve the selected user preferred level of detail includes reducing the number of passes through a multi-stage graphics pipeline.

6. The method of claim 1, wherein the step of adjusting the level of detail for the graphics display in order to achieve the selected user preferred level of detail includes reducing the amount data used to represent the graphics displayed by the portable device.

7. A level of detail management device for managing the level of detail in graphics displayed by a portable computer having a finite power source, said management device comprising:
a power statistics module for receiving statistical information related to the finite power source, including information about the amount of power remaining in the finite power source; and
a power level of detail management module for managing the level of detail in the graphics displayed by the portable computer, said power level of detail management module managing the level of detail in the graphics displayed by the portable computer as a function of the statistical information received by the power module.

8. The level of detail management device of claim 7, wherein the power level of detail management module adjusts the level of detail by reducing the number of floating point operations performed by the portable computer in displaying the graphics.

9. The level of detail management device of claim 7, wherein the power level of detail management module adjusts the level of detail by reducing the number of passes through a multi-stage graphics pipeline resident within said portable computer.

10. The level of detail management device of claim 7, wherein the power level of detail management module adjusts the level of detail by reducing the amount data used to represent the graphics displayed by the portable computer.

11. The level of detail management device of claim 7, wherein the power level of detail management module adjusts the level of detail in the graphics displayed by the portable computer to a pre-selected user preferred level of detail as a function of the statistical information received by the power module.

12. The level of detail management device of claim 11, wherein the power level of detail management device may invoke any one of or several different methods for adjusting the level of detail in the graphics, the method or methods being invoked being selected from a plurality of methods available for adjusting the level of detail of the graphics.

13. The level of detail management device of claim 12, further comprising a power/level of detail user interface control panel for allowing a user to select a series of plurality of user preferred levels of detail, each level of detail corresponding with a predetermined power level.

14. The level of detail management device of claim 13, wherein the power/level of detail user interface control panel allows a user to select which method or methods are invoked by the level of detail management device in order to adjust the level of detail of the graphics.

15. The level of detail management device of claim 13, wherein the power/level of detail user interface control panel includes a plurality of interactive slide switches which allow a user to select the plurality of user preferred levels of detail, each switch corresponding with a predetermined power level.

16. The level of detail management device of claim 15, further comprising:
a first adjustable slide switch corresponding with a high power level for selecting a first preferred level of detail to be implemented when the power source is operating at the high power level;
a second adjustable slide switch corresponding with a mid-power level for selecting a second preferred level of detail to be implemented when the power source is operating at the mid-power level; and
a third adjustable slide switch corresponding with a low power level for selecting a third preferred level of detail to be implemented when the power source is operating at the low power level.

17. The level of detail management device of claim 16, wherein the switch settings may be adjusted by using an input device to select the respective switch and slide the switch up or down, in order to adjust the level of detail for that corresponding power level.

18. A computer program product comprising computer readable program code for causing a processor and graphics card in a portable computer system to adjust the level of detail in an image to be displayed by the portable computer system as a function of the available power, said computer readable program code causing said processor and graphics card to:
obtain a plurality of user preferred levels of detail, each user preferred level of detail corresponding with a predetermined power level in a plurality of predetermined power levels;
determine a current power level;
select which user preferred level of detail to implement in displaying the graphics, said selection being a function of the current power level; and
adjust the level of detail for the graphics display in order to achieve the selected user preferred level of detail.

19. The computer program product of claim 18, wherein the computer readable program code further causes said processor and graphics card to:
provide a graphical user interface for allowing a user to enter preferred levels of detail, each preferred level of detail corresponding with a predetermined power level in a plurality of predetermined power levels; and
receive and store the user preferred levels of detail and their corresponding predetermined power levels.

20. The computer program product of claim 18, wherein the computer readable program code causes said processor and graphics card to adjust the level of detail in an image as a function of the available power by reducing the number of floating point operations.

21. The computer program product of claim 18, wherein the computer readable program code causes said processor and graphics card to adjust the level of detail in an image as a function of the available power by reducing the number of passes through a multi-stage graphics pipeline.

22. The computer program product of claim 18, wherein the computer readable program code causes said processor and graphics card to adjust the level of detail in an image as a function of the available power by reducing the amount data used to represent the graphics displayed by the computer system.

23. A computer program product for managing the level of detail in graphics displayed by a portable computer having a finite power source, said computer program product comprising computer readable program code for causing the portable computer to:
receive statistical information related to the finite power source, including information about the amount of power remaining in the finite power source; and
manage the level of detail in the graphics displayed by the portable computer as a function of the statistical information received.

24. The computer program product of claim 23, further comprising computer readable program code for causing the portable computer to:
compute a useful life of the power source as a result of the received statistical information related to the finite power source; and
adjust the level of detail in the graphics displayed by the portable computer in order to extend the useful life of the power source beyond the computed useful life.

25. The computer program product of claim 23, further comprising computer readable program code which includes a plurality of methods which may be invoked by the portable computer in order to adjust the level of detail of the graphics.

26. The computer program product of claim 25, further comprising computer readable program code for generating a power/level of detail user interface control panel for allowing a user to select which method or methods are invoked in order to adjust the level of detail of the graphics.
